(19) United States
(12) Patent Application Publication
(10) Pub. No.: US 2007/0281543 A1
(43) Pub. Date: Dec. 6, 2007

(54) Multipole Pin Strip

(76) Inventors: Andreas Boegelein, Regelsweiler (DE); Alexander Schmid, Alsbach (DE); Peter Goesele, Rohlingen (DE); Werner Schmidt, Durrwangen (DE)

Correspondence Address: BARLEY SNYDER, LLC, 1000 WESTLAKES DRIVE, SUITE 275, BERWYN, PA, 19312, US

(21) Appl. No.: 11/749,568

(22) Filed: May 16, 2007

(30) Foreign Application Priority Data
Jun. 3, 2006 (DE) 102006026104.6

(51) Int. Cl. H01R 13/40

(52) U.S. Cl. 439/590

(57) ABSTRACT

A multipole pin strip, comprising a body having a back, a plurality of electric pin contacts projecting from the back of the body, a pin contact holder located adjacent the back of the body and receiving the electric pin contacts therethrough, and the electric pin contacts being bent down on a back of the pin contact holder is disclosed

### CROSS-REFERENCE TO RELATED APPLICATIONS

This application claims the benefit of the filing date under 35 U.S.C. § 119(a)-(d) of German Patent 10 2006 026 104.6 of Jun. 3, 2006.

### FIELD OF THE INVENTION

The present invention relates to a pin strip, in particular, to a multipole pin strip for an engine control unit.

### BACKGROUND

A consequence of electrical component density currently achievable on printed circuit boards is that the conductor tracks on the circuit board that are used to bring in grounding connectors and signaling lines must also have high density. Connectors of components of printed circuit boards are also subject to these high density requirements. Thus, pin strips with 400 to 800 pin contacts per 100 mm edge length are now required. Due to the resultant high pin density involved, the problem arises that if individual pins or electrical pin contacts are not precisely enough aligned with each other, mounting on the circuit board or connecting a connector jack to the connector or the pin strip is difficult or altogether impossible. This may lead to an erroneous electrical contact when mounting the pin strip on a circuit board, or the pin contacts may not be inserted precisely enough into the corresponding openings of a connector jack. In the latter case, a problem is that while non-centric plugging together may establish a correct electrical contact, it can lead to failure of such electrical connection later on. In the former case, a problem encountered during processing of multipole pin strips is to reliably produce the requisite tolerances on one solder side of the electric pin contacts in order to connect the pin strip electrically to and properly bonding to a circuit board.

### SUMMARY

The invention relates to a multipole pin strip, comprising a body having a back, a plurality of electric pin contacts projecting from the back of the body, a pin contact holder located adjacent the back of the body and receiving the electric pin contacts therethrough, and the electric pin contacts being bent down on a back of the pin contact holder.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an oblique partially exploded view of a partially assembled body of a multipole pin strip according to the present invention; and

FIG. 2 is an oblique partially exploded view of the multipole pin strip of FIG. 1 in a partially mounted state.

### DESCRIPTION OF THE PREFERRED EMBODIMENTS

The invention is explained in greater detail in the following on a 181-pole pin strip for a printed circuit board of an engine control unit. However, the invention is not to be limited to such a multipole pin strip but generally comprises pin strips requiring narrow tolerances of electric pin contacts. This applies in particular to the size of a wobble circle of a back free end of each electric contact of the pin strip.

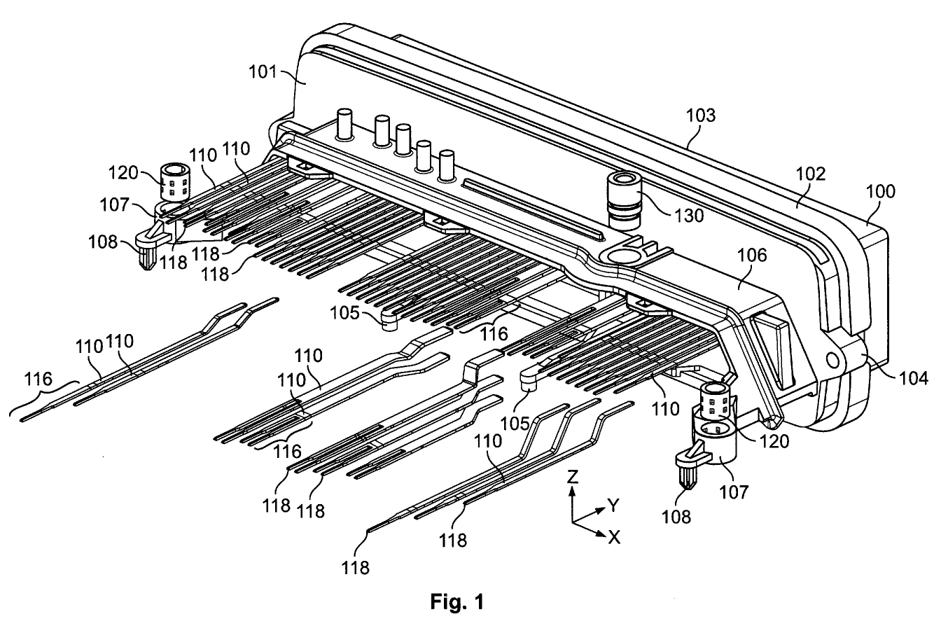

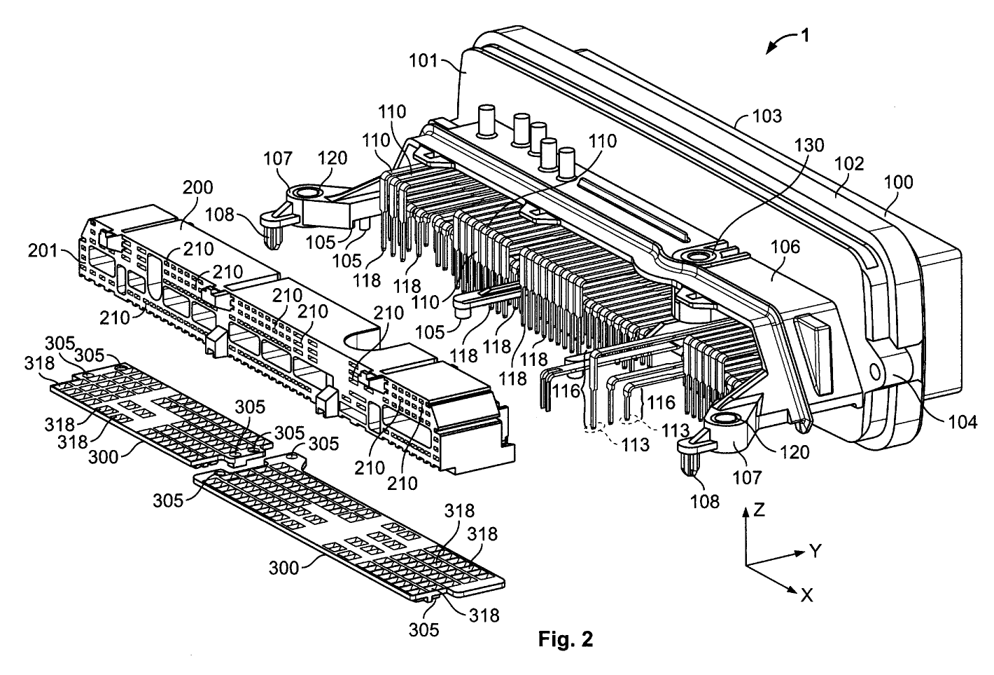

FIG. 1 shows an embodiment of a body 100 as it emerges from an injection-molding process in an injection-molding machine. The body 100 may be molded around electric pin contacts 110. For the sake of clarity, a great number of pin contacts 110 are omitted in FIG. 1 or offset electric pin contacts 110 in the foreground of FIG. 1 are shown in exploded view. In the production of pin strip 1 (see FIG. 2) not necessarily all pin contacts 110 need be molded into the body 110 but can partially or even entirely be provided in it by stitching.

The electric pin contacts 110 of pin strip 1 in accordance with the invention may each be formed for instance at both their free end sections as pin, tab, and/or jack contact. This may allow, depending on requirements, a mating connector (connector jack) to be pushed onto pin strip 1 or the free ends 118 of pin contacts 110 to be bonded on a back 101 of body 100. These free ends 118 may be soldered to conductor tracks of a printed circuit board and are then appropriately formed as pin contacts.

Body 100 may be constructed essentially as a cuboid, with pin contacts 110 being provided permanently connected with body 100 in a continuous central or lateral wall of this cuboid. The arrangement of pin contacts 110 in body 100 depends on the technical requirements of pin strip 1, with pin contacts 110 being preferably provided in a matrix arrangement in body 100 made up of a multitude of lines and a multitude of gaps. This is achieved by inlay molding and/or stitching of pin contacts 110.

Body 100 has a shoulder 102 that may completely encircle body 100, which, on the one hand, limits sliding of the mating connector onto pin strip 1, and on the other hand, provides a locking or stopping device 104 for the mating connector. In the present example, stopping device 104 is a boring through shoulder 102 with which the mating connector can be fastened to body 100 of pin strip 1.

Body 100 also comprises on its back 101 a receiving device 106 which covers a center section of pin contacts 110, at least on one side. The receiving device 106 which encircles, at least partially, the entirety of electric pin contacts 110 may be provided on body 100. If receiving device 106 is provided around all pin contacts 110 it has on one underside a recess (negative z-direction) to allow the free ends 118 or free end sections 116 of pin contacts 110 to be bent down and to bond electrically with the printed circuit board. Receiving device 106 can receive a pin contact holder 200 that is shown outside body 100 in FIG. 2 (discussed infra).

Body 100 comprises a leg 107, positioning pin 108, and bush 120, allowing it to be positioned and fixed on the circuit board. Positioning pin 108 may be provided on receiving device 106, but alternatively, may be also be provided on shoulder 102 or the body 100 itself. This may also be realized in a statically reversed arrangement. Leg 107 may be provided on device 106, but alternatively, may also be provided on shoulder 102 or on body 100 itself. In the embodiment shown, leg 107 is a plastic catch that has a clearance into which a press fit bush 120 is inserted. However, in an alternative embodiment, a component other than a bush 120, such as a screw or a rivet, may be inserted in the clearance, thereby fixing pin strip 1 to the circuit board. Press fit bush 120, may be made of metal and serves to stop leg 107 (plastic catch) with clearance from yielding when permanently connected with the circuit board. In the embodiment shown, positioning pin 108 is for insertion into a hole of the circuit board. It is of course also possible to provide the leg 107 shown with a different means for engaging the circuit board. Thus, it is possible for example, to lock it or to directly screw it into pin strip 1 with a screw coming from the underside of the circuit board. Positioning pin 108 and leg 107 may both be provided on the same plastic catch for an accurately fitting connection with the circuit board. Body 100 may also comprises an inserted or pressed-in bush 130 on receiving device 106 into which a cover for body 100 can be fixed. Such fixing may be accomplished by means of a screw cutting into metal bush 130.

FIG. 2 shows the almost completely assembled 181-pole pin strip 1, with four electric pin contacts 110 illustrated in exploded view. In the illustration of FIG. 2 the pin contact holder 200 is not shown in assembled position on body 100 but in an exploded position, so that pin contact holder 200 is easier to see. In assembled position, the pin contact holder 200 sits on body 100 in its receiving device 106. Pin contact holder 200 may be permanently connected with body 100. This may be accomplished by means of locking pin contact holder 200 together with body 100 or receiving device 106.

For purposes of mounting pin contact holder 200 on body 100, it is threaded onto pin contacts 110 before they are bent downwards and is moved forwards toward body 100, with pin contact holder 200 being subsequently fixed on body 100. Electric pin contacts 110 are then bent downward, possibly at a 90° angle. However, it is not necessary to bend pin contacts 110 at a right angle and depending on the application, they may be bent at a different angle.

Pin contact holder 200 is preferably constructed essentially cuboid and comprises a number of channels 210 in transverse direction through which pass electric pin contacts 110 in the assembled state of pin contact holder 200. A channel 210 for each pin contact 110 is formed in pin contact holder 200. Each channel 210 guides the respective pin contact 110 as tightly as possible so that it has the smallest possible freedom to move within channels 210. This is achieved with a clearance fit, preferably a tight clearance fit or in particular with a transition fit. The dimension of fit reaches its limits where the pin contact holder 200 can no longer be pushed onto electric pin contacts 110 without damaging a pin contact 110 and be moved forward towards body 100.

Freedom to move of each pin contact 110 is restricted by channels 210, so that a resultant wobble circle of each free end 118 of each pin contact 110 is smaller than that without using the pin contact holder 200. In particular, pin contact holder 200 positions pin contacts 110 in the z-direction, thereby reducing the free length and distortion of pin contacts 110 in the y-direction. This also results in smaller tolerances of projections of pin contacts 110 downward in direction of the circuit board.

In another embodiment of the invention, not shown in the drawings, the back 201 of pin contact holder 200 is formed such that pin contacts 110 protruding backwards in negative y-direction protrude in front of their angled backwardly free end sections 116 essentially with a same length from pin contact holder 200. This may apply also solely to part of pin contacts 110. For this purpose, the back 201 of pin contact holder 200 is stepped or slanted. This means that pin contact holder 200 of FIG. 2 would be constructed in an upper section (positive z-direction) further backwards in negative y-direction than its lower section. This causes the free ends 118 of pin contacts 110 having longer free end sections 116 to have smaller wobble circles. The extent to which such a slanted or stepped pin contact holder 200 must be used depends on the tolerances required of free ends 118 of pin contacts 110.

To further reduce the wobble circles of free ends 118 of pin contacts 110 or to reduce them to almost zero, one or several centering plates 300 centering the respective free ends 118 of pin contacts 110 may be provided below pin contact holder 200. Centering plate or plates 300 may be connected with a section of receiving device 106 in such a way that this section holds centering plates 300 at least in position. In one mounted position of pin strip 1 on the circuit board the positioning of centering plates 300 on receiving device 106 in engagement with the circuit board can definitively fix these. It is, however, also possible to provide the centering plates 300 fixed on receiving device 106. Centering plates 300 may be positioned near the positioning means 108 of body 100 on the circuit board and may be near a leg 107 of pin strip 1 on the circuit board. In one embodiment of the invention, all or at least any two of these are located at a single, possibly narrowly delimited point on body 100.

Positioning of centering plate 300 on body 100 is realized by way of guide posts 105 and guide holes 305 communicating with each other, whereby in the present example, a guide posts 105 is (a positioning pin and a positioning lug provided on leg 107) of receiving device 106, which engage guide holes 305 of centering plate 300. In this connection, the positioning pin guide post 105 engages in a corresponding guide hole 305 in centering plate 300 while the positioning lug guide post 105 engages a separate corresponding guide hole 305. It is, of course, also possible to provide only one guide post 105 or only one guide hole 305 on centering plate 300.

Centering plate or plates 300 has/have several apertures 318 through each of which extends one backward free end section 116 of a pin contact 110. This aperture 318 additionally limits the freedom to move of each free end 118 or each free end section 116 of each electric pin contact 110. Apertures 318 may be formed as centering clearances which have a tapering diameter or tapering internal dimensions. Such apertures 318 may be, for example, semi-spherical, conical, or pyramidal in shape on the inside. Here, each free end 118 has to pass through the larger diameter or lager dimensions of apertures 318 in the direction of insertion of a free end 118 through the apertures 318, and as the free end 118 is moved further forward, it centers itself automatically within the aperture 318. The smallest diameter or the smallest dimensions of apertures 318 correspond(s) approximately to the corresponding section of each pin contact 110 in this area. This in turn can be achieved through a clearance fit, a tight clearance fit, or a transition fit. The size of such fit depends on whether a free end section 116 of a single pin contact 110 fails to move with it upwards, for example, gets stuck when the centering plate 300 is pushed on. When the centering plate 300 is pushed onto the body 100 the pin contact free end 118 concerned is taken up by a comparatively large centering aperture 318 diameter and centered by the reducing centering aperture 318 diameter. This ensures that the free ends 118 of the electric pin contacts 110 are precisely positioned.

After positioning centering plate 300, it can be locked on body 100 or it can find its final position during mounting of body 100 on the circuit board. Thereafter the free ends 118 are soldered to the respective conductor tracks or circuit board pads of the printed circuited board.

By providing an improved pin strip 1 as described above, in particular an improved multipole pin strip 1 whose electrical strip contacts 110 are aligned such that narrow tolerances can be realized with them. This is to apply in particular to a section on the circuit-board side of a multipole pin strip 1 whose electric pin contacts 110 are soldered to a circuit board.

The body 100 as described above, restricts the freedom to move of the free ends 118 of the electric pin contacts 110 is restricted such that they comply with the necessary tolerances. In particular with multipole 90° pin strips 1 where electric pins or tabs are inlay-molded, thus giving a substantial free length of pin or tab, the large tolerances of the pin or tab projections are reduced. This applies in particular to the free ends of electric pin contacts 110 to be bonded with the circuit board. The wobble circles of the free ends 118 of electric pin contacts are thereby markedly reduced. The tolerance for the free ends 118 of electric pin contacts 110 lying opposite in the body is also reduced by the pin contact holder in accordance with this invention. This depends in particular on a length of the bearing of each electric pin contact 110 in the body 100.

After inlay-molding or molding-on of the body 100 and a possible stitching of electric pin contacts 110, the body 100 is pushed onto the electric pin contacts 110 in stitch direction before they undergo bending and preferably locked with the body 100.

The pin contact holder 200 has for each pin contact 110 one channel 210 which positions the pin contact 110 in one direction corresponding to a vertical direction of the unbent pin contact sections 116. This also reduces a free length and distortion of the pin contacts 110 after bending of the pin contacts 110 in stitch direction. In addition, the pin contact holder 200 also results in positioning of the pin contacts 110 in a direction along the pin contact holder 200 (turned at a 90° angle in relation to a plugging direction of a connector jack onto the pin strip 1 in accordance with the invention), so that the wobble circles of the pin contact free ends are altogether markedly smaller compared with the state of the art. Also, by providing the pin contact holder 200 in accordance with the invention the tolerances of the pin contact projections are reduced. The back of the pin contact holder 200 may be stepped. Providing the pin contact holder 200 on the body 100 also results in a simplified bending of the electric pin contacts 110 which thereby have a shorter projection for subsequent soldering to the circuit board conductor tracks.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multipole pin strip, comprising:
a body having a back;
a plurality of electric pin contacts projecting from the back of the body;
a pin contact holder located adjacent the back of the body and receiving the electric pin contacts therethrough; and
the electric pin contacts being bent down on a back of the pin contact holder.

2. The multipole pin strip according to claim 1, the pin contact holder comprising:
a channel which receives one electric pin contact;
wherein the channel is dimensioned to limit the possibilities of movement of the electric pin contact.

3. The multipole pin strip according to claim 1, the pin contact holder comprising:
a plurality of channels that each receive one electric pin contact;
wherein the channels are dimensioned so that a free end of each of the electric pin contacts has a wobble circle of substantially similar size.

4. The multipole pin strip according to claim 1, wherein a back of the pin contact holder is slanted in such a way that electric pin contacts which protrude further outward from the body have substantially similarly sized wobble circles as electric pin contacts which protrude outward from the body a lesser distance.

5. The multipole pin strip according to claim 1, wherein the pin contact holder can be locked onto the body.

6. The multipole pin strip according to claim 1, wherein a free end section of an electric pin contact is centered in a centering plate and wherein the centering plate is selectively connected with the body.

7. The multipole pin strip according to claim 6, wherein the free end section extends through an aperture in the centering plate.

8. The multipole pin strip according to claim 7, wherein the aperture of the centering plate has a reducing diameter.

9. The multipole pin strip according to claim 1, wherein the electric pin contacts form a matrix arrangement.

10. The multipole pin strip according to claim 1, wherein the electric pin contacts are bent at substantially a right angle.

11. The multipole pin strip according to claim 1, wherein the body is molded onto the electric pin contacts.
